(19) United States
(12) Patent Application Publication
(10) Pub. No.: US 2014/0052468 A1
(43) Pub. Date: Feb. 20, 2014

(54) Medication Adherence System for and Method of Monitoring a Patient Medication Adherence and Facilitating Dose Reminders

(71) Applicant: DoseCue, LLC, Philadelphia, PA (US)

(72) Inventors: Mark Burrows, Philadelphia, PA (US); Neal Eckhaus, Rochester, NY (US); Donald Grube, Rochester, NY (US); George Christoffersen, Cherry Hill, NJ (US)

(73) Assignee: DoseCue, LLC, Philadelphia, PA (US)

(21) Appl. No.: 14/042,768

(22) Filed: Oct. 1, 2013

Related U.S. Application Data
(63) Continuation-in-part of application No. 11/264,249, filed on Nov. 1, 2005.

(51) Int. Cl. G06F 19/00

(52) U.S. Cl. CPC G06F 19/3475
USPC 705/2

(57) ABSTRACT

A medication adherence system for and method of monitoring a patient's medication adherence and facilitating dose reminder notifications is disclosed. The medication adherence system includes data-enabled pharmaceutical containers, wherein the data-enabled pharmaceutical containers provide mechanisms for reminding at dose time, then tracking and communicating valid dose events, as well as missed, extra, early, and/or late dose events. The medication adherence system includes a centralized server for collecting and processing the patient-specific information from the data-enabled pharmaceutical containers. Information may be exchanged between the centralized server and the data-enabled pharmaceutical containers via a cellular network and/or the Internet.

### RELATED PATENT APPLICATIONS

This application is a continuation in part of U.S. patent application Ser. No. 11/264,249, filed Nov. 1, 2005, entitled “Method of Increasing Patient Medication Compliance using Reminder Devices Attached to Containers,” which is incorporated by reference herein in its entirety.

### FIELD OF THE INVENTION

The present invention generally relates to the field of medication adherence. In particular, the present invention is directed to a medication adherence system for and method of monitoring a patient's medication adherence and facilitating dose reminder notifications.

### BACKGROUND

Outpatient prescription medication treatments are relied upon heavily for increased quality of life and lower lifetime healthcare costs. Medical experts have long held that taking at least 80% of a prescribed drug is required to achieve desired therapeutic outcomes and lower lifetime healthcare costs. For example, a patient who faithfully takes cholesterol-reducing medicine significantly reduces the likelihood of a coronary event that has attendant cost-intensive medical procedures and diminished quality of life. Outpatients strongly desire to avoid such events and hospital stays, yet only 20% of all outpatients take their prescription medicines according to doctor's instructions.

Increased medication adherence, also known as patient adherence, medication adherence, or patient compliance, benefits the healthcare system by vastly reducing patients' lifetime medical costs while increasing their therapeutic outcomes. Further, market research suggests that patients have a desire to adhere, but will not take on the burden of any additional actions or otherwise change their behavior.

Attempts to date to increase patient adherence have involved attaching dosage-reminder devices to containers by pharmacists, patients, or patient's caregivers. These have had no perceivable impact on adherence, principally because such devices increase, rather than lessen, patients' burden in taking medication. These devices rely on patients for programming, record keeping, decanting, or pressing an event button. While variations of such devices have been around for many years, pharmacists have not been rewarded for taking the time to program and attach them and patients have not been willing to pay for and/or otherwise adopt them.

### SUMMARY OF THE INVENTION

In one embodiment, the invention provides a medication adherence system. The medication adherence system may include an application server; a data-enabled pharmaceutical container; and a communication device, wherein the communication device is in communication with the application server and the data-enabled pharmaceutical container. The communication device may be in communication with the application server and the data-enabled pharmaceutical container via a network. The network may include a cellular network. The application server may include a centralized server. The application server may include a cloud server. The application server may include a medication adherence application and a database. The database may be configured to store at least one or more of subscription data, summary reports, and exception reports. The data-enabled pharmaceutical container may include control electronics for one or more of providing reminders at dose time, tracking and communicating valid dose events, missed, extra, early, and late dose events. The data-enabled pharmaceutical container further may include a dose detection algorithm, wherein a dose event is tracked as valid based on sensing that the data-enabled pharmaceutical container is both opened and tilted past a pre-defined minimum threshold angle simultaneously for a pre-defined minimum amount of time. The communication device may include a cellular-enabled mobile device. The communication device may include a mobile telephone. The communication device may include a medication adherence mobile/desktop application configured to run on the communication device. The communication device may be associated with a particular user (e.g., patient). The medication adherence mobile/desktop application and the medication adherence application may communicate via the network. The data-enabled pharmaceutical container and the communication device may be in one of wired or wireless communication. The communication device may communicate with the application server via a cellular network. The application server may be configured for collecting and processing user specific information from the data-enabled pharmaceutical container transmitted via the communication device. The medication adherence system may include a subscription-based system. The system further may include one or more notifiers. The system of further may include one or more notifier communication devices associated with the one or more notifiers, wherein the one or more notifier communication devices are in communication with the application server. The one or more notifier communication devices may include any one of a mobile telephone, a landline phone, or any computing device. The network may provide at least one of a wired or wireless connection to the Internet. The communication device may include a computing device. The computing device may include one of a desktop computer, laptop computer, handheld computing device, mobile phone, personal digital assistant (PDA), or tablet device. The computing device may include a mobile/desktop medication adherence application. The computing device may be configured to be in one of wired or wireless communication with the data-enabled pharmaceutical containers. The communication device may include a modem. The modem may include a landline modem. The system may be configured to utilize any one or more of a cellular network, an Internet connection, or modem for communication.

In one embodiment, the invention provides a method of using a medication adherence system. The method may include automatically recording a user's actual dose information via a data-enabled pharmaceutical container; communicating the user's actual dose information from the data-enabled pharmaceutical container to a communication device; communicating the user's actual dose information from the communication device to an application server; processing the user's actual dose information communicated from the communication device and compiling a user specific summary based on the user's actual dose information; recording any user specific dose exceptions; and notifying at least one of the user, one or more notifiers, or an authorized personnel of the user specific dose exceptions. The method of claim 30 wherein processing the user's actual dose information comprises compiling a user specific summary based on the user's actual dose information. The communication device and application server may include a medication adherence mobile/desktop application and a medication adherence application respectively. The user's actual dose information may include valid dose events detected by the data-enabled pharmaceutical container. The valid dose events may include the data-enabled pharmaceutical container being both opened and tilted past a pre-defined minimum threshold angle simultaneously for a pre-defined period of time. The user's actual dose information may be compared to information in a user's prescribed dosing regimen. The user's actual dose information may be communicated over a network. The data-enabled pharmaceutical container may push the contents of the user's actual dose information to the communication device in real-time, scheduled intervals, and/or on demand. The communication device may include a one of a mobile phone or a computing device. The communication device may pull the contents of the user's actual dose information from the data-enabled pharmaceutical container in real-time, scheduled intervals, and/or on demand. The user's actual dose information may be communicated from the medication adherence user specific dose exceptions application to the medication adherence application of the application server. The user's actual dose information may be communicated from the medication adherence mobile/desktop application of the communication device to the medication adherence application of the application server. The user's prescribed dosing regimen may be communicated to the application server. The user specific dose exceptions may include any one or more of a missed dose, extra dose, early dose, and/or late dose. The notifying may include any one or more of email, text message, telephone call, page, and/or instant message. The one or more notifiers or authorized personnel further may include notifying the user and/or other authorized personnel of the user specific dose exceptions. The user specific dose exceptions notification may be automatically communicated to at least one of the user, one or more notifiers, or authorized personnel. The communication device may include a modem. The modem may include a landline modem. The communicating may be via any one or more of a cellular network, an Internet connection, or modem.

### BRIEF DESCRIPTION OF THE DRAWINGS

Having thus described the presently disclosed subject matter in general terms, reference will now be made to the accompanying Drawings, which are not necessarily drawn to scale, and wherein:

FIG. 1 illustrates a block diagram of a medication adherence system for monitoring a patient's medication adherence and facilitating dose reminder notifications according to one embodiment of the invention;

FIG. 2 illustrates a block diagram of a medication adherence system for monitoring a patient's medication adherence and facilitating dose reminder notifications according to another embodiment of the invention;

FIG. 3 illustrates a perspective view of an example of a data-enabled pharmaceutical container for reminding at dose time, then tracking and communicating valid dose events, as well as missed, extra, early, and/or late dose events;

FIG. 4 illustrates a block diagram of an example of control electronics of the data-enabled pharmaceutical container used in the presently disclosed medication adherence system;

FIG. 5 illustrates a flow diagram of an example of a method of using the presently disclosed medication adherence system for monitoring a patient's medication adherence and facilitating dose reminder notifications; and

FIG. 6 illustrates a block diagram of a medication adherence system for monitoring a patient's medication adherence and facilitating dose reminder notifications according to yet another embodiment of the invention.

### DETAILED DESCRIPTION

The presently disclosed subject matter provides a medication adherence system for monitoring a patient's medication adherence and facilitating dose reminder notifications. The medication adherence system preferably includes one or more data-enabled pharmaceutical containers, wherein the data-enabled pharmaceutical containers provide mechanisms for one or more of reminding at dose time, then tracking and communicating valid dose events, as well as missed, extra, early, and/or late dose events. The medication adherence system may include a centralized server for collecting and processing the patient-specific information from the data-enabled pharmaceutical containers.

In one embodiment, the patient's data-enabled pharmaceutical container may transmit information wirelessly to a patient's mobile phone, or other similar device. Then, the patient's mobile phone is used to transmit (e.g., via cellular network) the patient-specific information to the centralized server, such as a cloud server or the like.

In another embodiment, the patient's data-enabled pharmaceutical container may transmit information wirelessly to the patient's computing device, or other similar device. Then, the patient's computing device is used to transmit (e.g., via the Internet) the patient-specific information to the centralized server.

The centralized server may be used to analyze the information from the patient's data-enabled pharmaceutical container, wherein the information may include records about valid dose events, missed dose events, late dose events, and/or extra dose events. If missed dose events are indicated, the patient may be notified of the missed dose, thereby prompting or reminding the patient to take his/her medication and thereby remain in adherence to his/her dosing regimen. The reminder notification may be by electronic means (e.g., email, text message, voicemail message, or the like), by a personal phone call (or other similar mechanisms), or by both electronic means and a personal phone call.

Further, using the information from the patient's data-enabled pharmaceutical container, exception reports and/or summary reports may be automatically generated (or generated on demand) at the centralized server and made available to any authorized parties, such as to the patient, a family member of the patient, the patient's caregiver, the patient's physician, the patient's pharmacist, and/or to any other authorized party or parties.

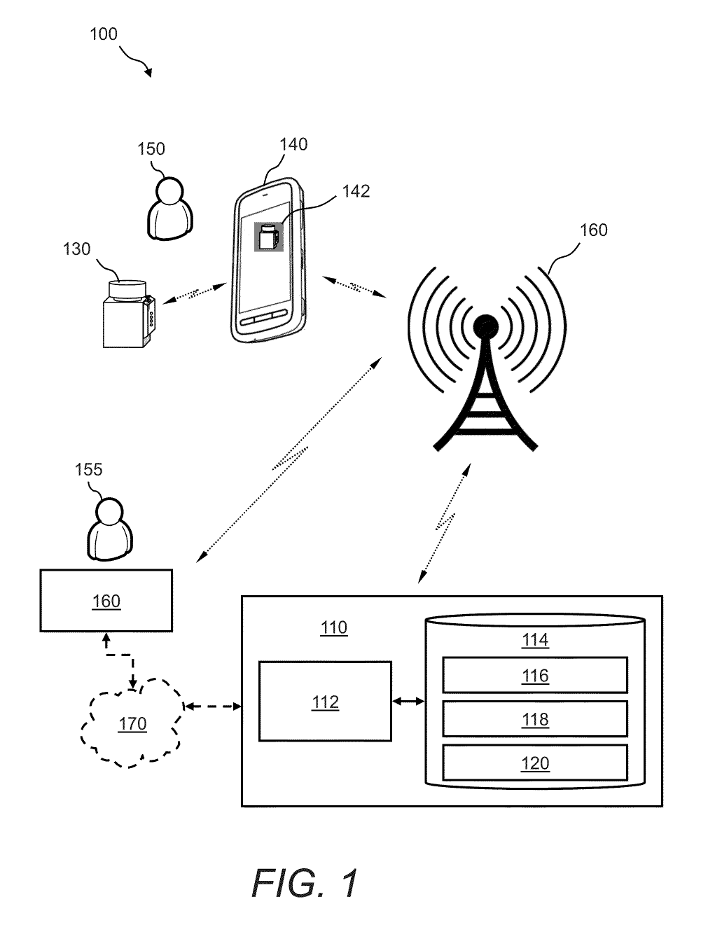

FIG. 1 illustrates a block diagram of a medication adherence system 100 for monitoring a patient's medication adherence and facilitating dose reminder notifications according to one embodiment of the invention. Namely, in medication adherence system 100, communication may be facilitated primarily via a cellular network, or other like network. The medication adherence system 100 may include an application server 110. The application server 110 may be any centralized server or computer that is accessible via a network. In one example, the application server 110 may be a cloud server. Residing at the application server 110 may be a medication adherence application 112 and a database 114. Stored at the database 114 may be, for example, one or more of subscription data 116, summary reports 118, and exception reports 120.

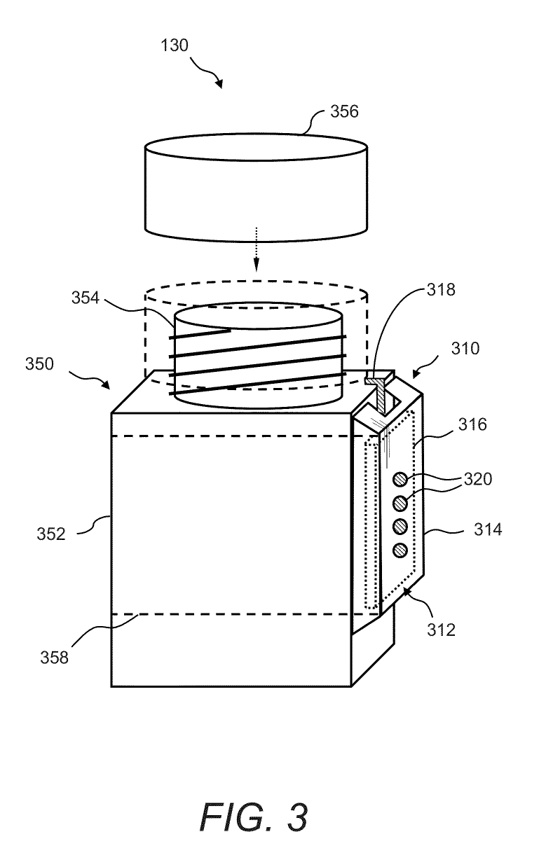

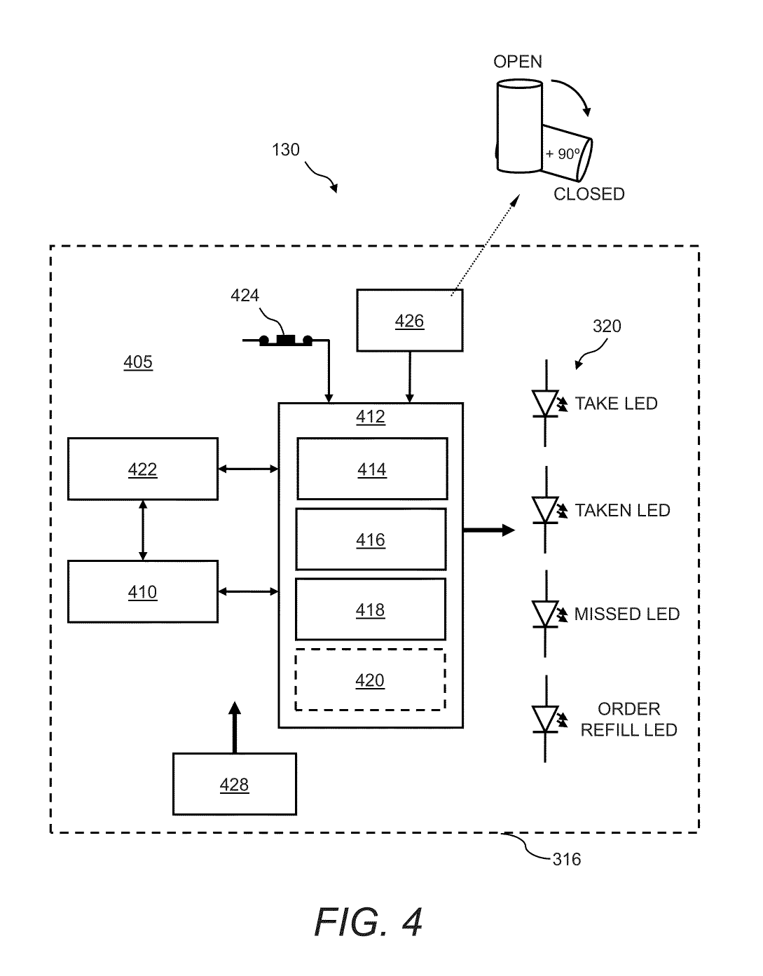

The medication adherence system 100 also may include a data-enabled pharmaceutical container 130. The data-enabled pharmaceutical container 130 preferably includes mechanisms for reminding at dose time, then tracking and communicating valid dose events, as well as missed, extra, early, and/or late dose events. The data-enabled pharmaceutical container 130 preferably includes control electronics for processing and communicating information about valid dose events, missed dose events, and/or extra dose events. For example, using a dose detection algorithm, a dose event is deemed valid based on (1) sensing an open state of the data-enabled pharmaceutical container 130 (i.e., sensing that a closure is not present), (2) sensing a certain orientation or tilt of the data-enabled pharmaceutical container 130, and (3) sensing that the data-enabled pharmaceutical container 130 is both opened and tilted simultaneously for a certain amount of time (e.g., a few seconds). The data-enabled pharmaceutical container 130 is based on the data-enabled pharmaceutical container that is described with reference to U.S. patent application Ser. No. 14/042,767, filed Oct. 1, 2013, entitled “Data-Enabled Pharmaceutical Container and Methods for Using Same,” which is incorporated by reference herein in its entirety, and which is summarized hereinbelow with reference to FIG. 3 and FIG. 4.

The medication adherence system 100 also preferably includes a mobile phone 140. The mobile phone 140 can be any mobile phone that is capable of (1) running mobile applications and (2) communicating with data-enabled pharmaceutical container 130. The mobile phone 140 may be, for example, an Android phone, an Apple iPhone, or a Samsung Galaxy phone. The mobile phone 140 may also be any other mobile device that has cellular network capability, such as a cellular-enabled tablet device (e.g., 3G or 4G version of the Apple iPad).

In medication adherence system 100, a medication adherence mobile app 142 is running on the mobile phone 140. The medication adherence mobile app 142 is the counterpart to the medication adherence application 112 that is running at the application server 110. The data-enabled pharmaceutical container 130 and the mobile phone 140 are associated with a patient 150 that is associated with the medication adherence system 100.

In the medication adherence system 100, data-enabled pharmaceutical container 130 of the patient 150, can transmit information wirelessly to the patient's mobile phone 140. Then, the patient's mobile phone 140 is used to transmit (e.g., via a cellular network 160) the patient-specific information to the application server 110, wherein the application server 110 is preferably used for collecting and processing patient-specific information from the data-enabled pharmaceutical container 130.

The medication adherence system 100 is not limited to one patient 150 and his/her one data-enabled pharmaceutical container 130 and one mobile phone 140. The medication adherence system 100 can support any number of patients 150, data-enabled pharmaceutical containers 130, and mobile phones 140, wherein the application server 110 collects and processes patient-specific information from multiple patients 150 and/or data-enabled pharmaceutical containers 130. Any given patient 150 may have multiple data-enabled pharmaceutical containers 130, which correspond to multiple medication prescriptions. In one example, the medication adherence system 100 may be implemented in a client-server type of system architecture, wherein the mobile phones 140 are the clients and the application server 110 is the server.

Further, the medication adherence system 100 may be a subscription-based system, wherein patients 150 subscribe to the medication adherence system 100 in order to download the medication adherence mobile app 142 to their mobile phones 140 and to take advantage of the functionality of the medication adherence application 112 at application server 110. The subscription data 116 in the database 114 at the application server 110 may contain, for example, patient names, patient account information, patient credentials, patient profiles, a record of the patient's prescriptions, and the like. The exception reports 120 in the database 114 are patient-specific exception information, wherein examples of exceptions include, but are not limited to, missed doses, extra doses, early doses, and late doses. The medication adherence application 112 determines patient-specific exceptions and generates patient-specific summary reports 118 by analyzing patient-specific information that is generated at each patient 150's data-enabled pharmaceutical container 130 and then transmitted to application server 110 via each patient 150's mobile phone 140. Further, a healthcare provider or group, research group, drug company, and/or other interested party or group may subscribe to the medication adherence system 100, with access to certain information restricted or sensitized based on the parties level of access.

Associated with the medication adherence system 100 may be one or more notifiers 155. In one example, when an exception occurs (e.g., missed, extra, early, and/or late dose), notifiers 155 may be any authorized personnel that are tasked to contact the patient 150 and notify them of the exception. Associated with the one or more notifiers 155 are their respective communication devices 160. The communication device 160 is, for example, a mobile phone, a landline phone, any computing device, or any other device capable of receiving communications. For example, using a telephone, a notifier 155 can call a certain patient 150 and notify him/her that a dose of medication was recently missed, thereby providing a reminder to get caught up on his/her dosing regimen. In another example, exception notifications can be transmitted electronically to the patient 150, such as via email, text message, or the like. The communication devices 160 of the notifiers 155 may be connected to the application server 110 via the cellular network 160, via a network 170, or optionally any other network or system capable of connecting the communication devices 160 of the notifiers 155 to the application server 110. The network 170 may be any network for providing wired or wireless connection to the Internet, such as a local area network (LAN) or a wide area network (WAN).

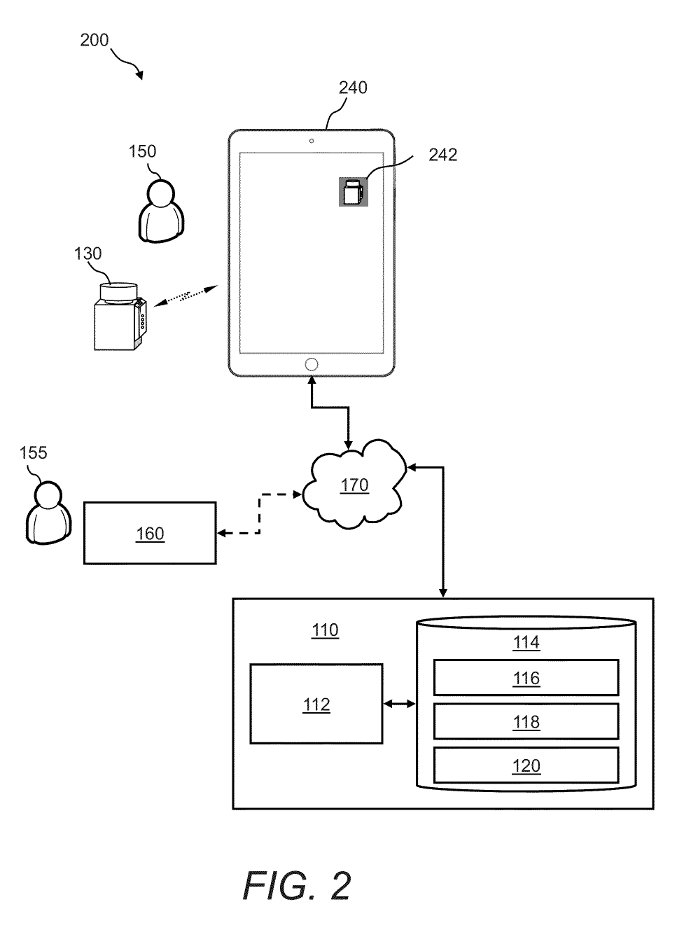

FIG. 2 illustrates a block diagram of a medication adherence system 200 for monitoring a patient's medication adherence and facilitating dose reminder notifications according to another embodiment of the invention. Namely, in medication adherence system 200, communication is preferably facilitated primarily via the Internet. That is, the medication adherence system 200 is substantially the same as the medication adherence system 100 of FIG. 1, except that the cellular network 160 is preferably replaced with the network 170. Further, the mobile phones 140 with their medication adherence mobile apps 142 are preferably replaced with computing devices 240, wherein each of the computing devices 240 may include a mobile/desktop medication adherence application 242 running thereon. The computing devices 240 may be, for example, desktop computers, laptop computers, handheld computing devices, mobile phones, personal digital assistants (PDAs), and tablet devices. The computing devices 240 preferably have wireless communication capabilities for communicating with the data-enabled pharmaceutical containers 130. For example, the computing device 240 may be Bluetooth®-enabled, Wi-Fi-enabled, and/or any other wireless communication interface-enabled for communicating wirelessly with other local devices, such as the data-enabled pharmaceutical container 130. The computing device 240 may be, for example, an Apple iPad.

Like the medication adherence mobile app 142 of FIG. 1, the mobile/desktop medication adherence application 242 is the counterpart to the medication adherence application 112 that is running at the application server 110.

FIG. 3 illustrates a perspective view of an example of the data-enabled pharmaceutical container 130 for reminding at dose time, then tracking and communicating valid dose events, as well as missed, extra, early, and/or late dose events. The data-enabled pharmaceutical container 130 includes an electronics module 310 that is attached or otherwise affixed to a pharmaceutical container 350. The pharmaceutical container 350 can be substantially any pharmaceutical container in use today. In the example shown in FIG. 3, the pharmaceutical container 350 may include a container body 352 and a container neck 354. The container body 352 is a reservoir for holding, for example, a quantity of pills, capsules, caplets, and the like, which are prescribed to a patient (not shown) according to a certain dosing regimen. The container neck 354 is preferably the opening for dispensing medication from the container body 352. In this example, the container neck 354 may be threaded for receiving a closure 356, which is a screw-type cap. The pharmaceutical container 350 (i.e., the container body 352, the container neck 354, and the closure 356) may be formed of any suitably rigid, lightweight, and food-safe material, such as molded high-density polyethylene (HDPE), i.e., molded plastic.

The electronics module 310 includes active and passive electrical components for sensing the presence or absence of the closure 356, for sensing the orientation or tilt of the pharmaceutical container 350, for processing these sensing mechanisms with respect to the patient's dosing regimen, and for storing and communicating information about doses taken, doses missed, and/or extra doses.

Namely, the electronics module 310 includes a printed circuit board (PCB) assembly 312 that may be enclosed in a housing 314, wherein the shape and size of the housing 314 may vary according to the shape and size of the pharmaceutical container 350. The housing 314 may be formed, for example, of the same material that the pharmaceutical container 350 is formed of (e.g., molded plastic). The PCB assembly 312 further may include a PCB 316 on which the control electronics (see FIG. 4) is preferably implemented, a movable lever 318, one or more indicators 320, and various other switches and sensors (again see FIG. 4).

The lever 318 preferably extends through an opening in the housing 314 and toward the container neck 354 as shown. The lever 318 is part of the mechanism for sensing whether the closure 356 is present at or absent from the container neck 354, meaning whether the data-enabled pharmaceutical container 130 is closed or opened. Namely, when the closure 356 is present (i.e., when the data-enabled pharmaceutical container 130 is closed) the edge of the closure 356 comes into contact with the tip of the lever 318, which causes the lever 318 to be in one position. However, when the closure 356 is not present (i.e., when the data-enabled pharmaceutical container 130 is opened) the edge of the closure 356 is not in contact with the tip of the lever 318, which causes the lever 318 to be in a different position. The lever 318 is used in conjunction with a momentary contact switch (see FIG. 4) for sensing when the data-enabled pharmaceutical container 130 is opened or closed.

The housing 314 and the PCB assembly 312 are preferably provided on the outside of the container body 352, such that there is substantially no contact with the contents inside of the container body 352. In one example, the housing 314 and the PCB assembly 312 are affixed to the container body 352 using a sleeve or label 358, wherein the sleeve or label 358 is wrapped around both the container body 352 and the housing 314 so that the housing 314 is affixed thereto and may be substantially hidden from view. The sleeve or label 358 may be formed of any material suitable to be printed on and preferably suitable to last the lifetime of the data-enabled pharmaceutical container 130.

FIG. 4 illustrates a block diagram of an example of control electronics 405 of the electronics module 310 of the data-enabled pharmaceutical container 130 for detecting valid dose events, as well as for processing and communicating information about valid dose events, as well as missed, extra, early, and/or late dose events. The control electronics 405 may be circuitry that is implemented on the PCB 316. In this example, the control electronics 405 may include a communications interface 410; a processor 412 that may further include the patient's dosing regimen 414, a dose detection algorithm 416, actual dose information 418, and optionally a security component 420; a real-time clock 422; a momentary contact switch 424; a tilt sensor 426; and one or more indicators 320. The components of the control electronics 405 may be powered by one or more batteries 428. Each of the batteries 428 may be any standard battery, such as quadruple-A, triple-A, or double-A, or a battery from the family of button cell and coin cell batteries. A specific example of a battery 428 may be a CR2032 coin cell 4-volt battery.

The communications interface 410 may be any wired and/or wireless communication interface for connecting to a network (not shown) and by which information may be exchanged with other devices connected to the network. Examples of wired communication interfaces may include, but are not limited to, USB ports, RS232 connectors, RJ45 connectors, Ethernet, and any combinations thereof. Examples of wireless communication interfaces may include, but are not limited to, an Intranet connection, Internet, ISM, Bluetooth® technology, Wi-Fi, Wi-Max, IEEE 402.11 technology, radio frequency (RF), Infrared Data Association (IrDA) compatible protocols, Local Area Networks (LAN), Wide Area Networks (WAN), Shared Wireless Access Protocol (SWAP), any combinations thereof, and other types of wireless networking protocols. Examples of information facilitated by the communications interface 410 may include the transmission of the dosing regimen 414 and the actual dose information 418. Other examples of information facilitated by the communications interface 410 may be the transmission of a “missed dose” alert, a “refill” alert, and/or an “extra dose” alert to the patient, to a caretaker, and/or to any other authorized party.

Processor 412 is preferably used to manage the overall operations of the data-enabled pharmaceutical container 130 with respect to reminding at dose time, then tracking and communicating valid dose events and/or missed, early, and/or late dose events. The processor 412 can be any standard controller or microprocessor device that is capable of executing program instructions. A certain amount of data storage (not shown) may be associated with the processor 412.

Using the communications interface 410, a patient's dosing regimen 414 may be loaded into processor 412. The dosing regimen 414 may be any information about the patient's medication and prescribed dosing regimen. In one example, the patient's dosing regimen 414 may indicate one 50-mg dose per day of levothroxine. In another example, the patient's dosing regimen 414 may indicate two 50-mg doses daily (e.g., one dose every 12 hours) of levothroxine. In yet another example, the patient's dosing regimen 414 may indicate three 50-mg doses daily of levothroxine (e.g., one dose upon waking, one mid-day dose, and one dose at bedtime).

The dose detection algorithm 416 that is preferably programmed into the processor 412 is preferably used to detect valid dose events. For example, a dose event may be deemed valid based on (1) sensing the open state of the data-enabled pharmaceutical container 130 (i.e., sensing that the closure 356 is not present), (2) sensing a certain orientation or tilt (e.g., greater than 90 degrees from vertical, or past horizontal) of the data-enabled pharmaceutical container 130, and (3) sensing that the data-enabled pharmaceutical container 130 is both opened and tilted simultaneously for a certain amount of time (e.g., a few seconds). Using the aforementioned criteria, incidental movement of the data-enabled pharmaceutical container 130, such as the container falling over or being jostled in a computer bag or a purse, will not register by the dose detection algorithm 416 as a valid dose event.

With respect to sensing the open state of the data-enabled pharmaceutical container 130 (i.e., sensing that the closure 356 is not present), the lever 318 is preferably engaged with an actuator (e.g., pushbutton) of the momentary contact switch 424. Together, the lever 318 and the momentary contact switch 424 provide a sensing mechanism for determining whether the data-enabled pharmaceutical container 130 is opened or closed. When the closure 356 is present and in contact with the tip of the lever 318, a portion of the lever 318 is pushed against the actuator of the momentary contact switch 424, and the momentary contact switch 424 is in one state (e.g., closed. By contrast, when the closure 356 is not present and therefore not in contact with the tip of the lever 318, the lever 318 is not pushed against the actuator of the momentary contact switch 424, and the momentary contact switch 424 is in another state (e.g., open).

The data-enabled pharmaceutical container 130 is not limited to using the lever 318 and the momentary contact switch 424 for sensing whether the data-enabled pharmaceutical container 130 is opened or closed. Other mechanisms can be used, such as, but not limited to, the mechanisms described with reference to U.S. Pat. No. 8,067,935, filed Jun. 5, 2008, entitled “System for sensing the opening and closing of a pharmaceutical container,” which is incorporated by reference herein in its entirety. The '935 patent describes multiple embodiments of mechanisms for sensing the opening and closing of pharmaceutical containers. In particular, The '935 patent describes sensing mechanisms that trigger an automatic, built-in, electronic dosage reminder and open/close event logging operation while requiring no additional actions or otherwise changed behavior by the patient, in order to increase patient compliance with dosing regimens. In one embodiment, the sensing mechanism includes two electrical conductors that have no electrical connection therebetween when the closure is not present on the container and a bridge conductor in the closure that provides an electrical connection therebetween when the closure is tightened onto the container. In this example embodiment, the state of the two electrical conductors may be monitored in order to sense a container opening and closing event.

The tilt sensor 426 is used for sensing orientation or tilt of the data-enabled pharmaceutical container 130. A tilt sensor 426 can measure the tilting in often two axes of a reference plane in two axes. In one example, tilt sensor 426 may be a SQ-SEN-390 on/off tilt sensor, available from SignalQuest, Inc (Lebanon, N.H.). The SQ-SEN-390 on/off tilt sensor acts like a position sensitive switch that is normally closed when below horizontal and normally open when above horizontal. With respect to the data-enabled pharmaceutical container 130, when the container body 352 is tilted beyond horizontal (e.g., past 90 degrees), the state of the tilt sensor 426 preferably indicates that the container body 352 is in a position to potentially dispense (dump out) a dose, such as a pill or capsule. Accordingly, the state of the tilt sensor 426 may be another input of the dose detection algorithm 416 that is used for detecting valid dose events.

The data-enabled pharmaceutical container 130 is not limited to using the SQ-SEN-390 on/off tilt sensor for sensing orientation or tilt. Other mechanisms can be used for sensing tilt, such as, but not limited to, an accelerometer, an inertial measurement unit (IMU), an inclinometer, or other suitable mechanism. Further, the data-enabled pharmaceutical container 130 is not limited to sensing orientation past 90 degrees. Less tilt than 90 degrees can be detected as needed with the above noted mechanisms for sensing tilt for specific uses, such as liquids, which may be dispensed from full containers with, for example, about in the range of 45 degrees of tilt.

With respect to sensing that the data-enabled pharmaceutical container 130 is both opened and tilted simultaneously for a certain amount of time (e.g., a few seconds), the internal clock of the processor 412 and/or the real-time clock 422 may be used. For example, upon sensing both that the closure 356 is not present and a tilt below horizontal, or threshold degree value, the internal clock of the processor 412 or the real-time clock 422 may be used to measure the amount of time that both conditions are simultaneously present. If both conditions are present at the same time for the defined minimum time, for example, in the range of about 2-4 seconds, then the dose detection algorithm 416 logs the date and time of a valid dose event in the actual dose information 418. Accordingly, the time of both conditions being present may be yet another input of the dose detection algorithm 416 that is used for detecting valid dose events. Any valid dose events that are detected via dose detection algorithm 416 are logged in the actual dose information 418. For example, the date and time of the dose event may be logged in the actual dose information 418.

Additionally, the processor 412 and/or the dose detection algorithm 416 can be programmed to compare valid dose events that are detected to information stored in the patient's dosing regimen 414. In so doing, it can be determined whether the prescribed dosing regimen is being followed. Namely, using the patient's dosing regimen 414, it can be determined whether doses have been taken on time, whether doses have been missed, whether extra doses have been taken, whether early doses have been taken, and whether late doses have been taken. Additionally, using the patient's dosing regimen 414, the processor 412 and/or the dose detection algorithm 416 can be used to activate reminder indicators and/or any other types of indicators. Namely, the real-time clock 422 provides a calendar and time of day function that can be used with the dosing regimen 414 in order to determine whether doses have been taken on time, whether doses have been missed, whether extra doses have been taken, whether early doses have been taken, and/or whether late doses have been taken, and to generate reminders. An example of the real-time clock 422 may be an S-35390A, 2-wire CMOS real-time clock, available from Seiko Instruments, Inc (Torrance, Calif.).

The optional security component 420 in the processor 412 may be any software module that is used to perform any security functions with respect to keeping the contents of, for example, the dosing regimen 414 and the actual dose information 418 secure. For example, the security component 420 may use standard security techniques, such as encryption, secure hashtags (or hash tags), and the like. For example, the security component 420 can be used to decrypt the dosing regimen 414, which may be received encrypted. Additionally, the security component 420 can be used to encrypt the actual dose information 418 when transmitted via communications interface 410. However, the use of encryption in the data-enabled pharmaceutical container 130 is optional.

The one or more indicators 320 may be used to convey information to the patient, caretaker, or other authorized party in response to the information processed via processor 412 and/or the dose detection algorithm 416. In one example, the indicators 320 may be light-emitting diode (LED) devices. For example, four indicators 320 may be provided—e.g., a green “TAKE” LED, a light green “TAKEN” LED, a red “MISSED” LED, and a yellow “ORDER REFILL” LED. Openings (not shown) may be provided in the housing 314 and/or in the sleeve or label 358 of the data-enabled pharmaceutical container 130 that allow the indicators 320 to be visible. Further, TAKE, TAKEN, MISSED, and ORDER REFILL may be printed on the sleeve or label 358 corresponding to the four indicators 320.

In the example above, the green “TAKE” LED may be used for prompting the user to take the prescribed dose of medication. For example, the information contained within the dosing regimen 414 may indicate a patient should take one dose at 4:00 pm daily. When the real-time clock 422 indicates the current time to be about 4:00 pm, the processor 412 activates the “TAKE” LED. In another example, if the dosing regimen 414 indicates 2 doses daily, 12 hours apart, then the “TAKE” LED may be activated about 12 hours after the previously detected valid dose event.

In the example above, upon detecting a valid dose event via dose detection algorithm 416, the “TAKE” LED may be deactivated and the light green TAKEN″ LED may be activated. Namely, the “TAKEN” LED indicates that a valid dose event has occurred as detected via dose detection algorithm 416. For example, if all criteria of the dose detection algorithm 416 are met, the processor 412 activates the “TAKEN” LED. After the valid dose event is detected, the “TAKEN” LED may remain activated (e.g., continues to flash) for some period of time (e.g., an hour or until the next dose time).

In the example above, the red “MISSED” LED indicates a user has not taken the dose of medication in accordance to the dosing regimen 414. Using the real-time clock 422, the processor 412 may be programmed to activate the “MISSED” LED, for example, one hour past the scheduled dose time. For example, the information contained within the dosing regimen 414 may indicate a patient should take one dose at 4:00 pm daily. In this example, when the real-time clock 422 indicates the current time is 5:00 pm and a dose event has not recently been detected via dose detection algorithm 416, the processor 412 activates the “MISSED” LED. The “MISSED” LED may remain activated for a predetermined period of time (e.g., 1 hour) or until the “TAKE” LED is next activated. Additionally, using the communications interface 410, a “missed dose” alert may be transmitted to the patient, caretaker, or any other authorized party.

In the example above, the yellow “ORDER REFILL” LED indicates the bottle is nearly out of medication and a prescription refill is needed. For example a patient's dosing regiment may require one dose per day for 30 days. Therefore, an initial fill of medication is 30 pills. The total number of pills contained within the data-enabled pharmaceutical container 130 (e.g., 30 pills) is indicated in the dosing regimen 414. The processor 412 can count the number of valid dose events logged in the actual dose information 418 and determine how many doses presently remain in the data-enabled pharmaceutical container 130. In addition to dose count, the processor 412 may use real-time clock 422 to verify that, for example, at least 25 days have passed since the last refill (for a 30-day prescription), as health insurance companies typically will not authorize monthly refills until 25 days have passed since the last refill (for a 30-day prescription). In another example, for a 90-day prescription, the time period may be 85 days. Once the number of doses is nearly depleted (e.g., 5 doses remaining) and the prescribed number of days have passed (e.g., 25 days or 85 days), the processor 412 activates the “ORDER REFILL” LED to indicate that a refill is needed. Additionally, using the communications interface 410, a “refill” alert may be transmitted to the patient, caretaker, or any other authorized party.

The operation of the data-enabled pharmaceutical container 130 can be summarized as follows. The dose detection algorithm 416 is used to detect valid dose events. For example, by monitoring the states of the momentary contact switch 424, the tilt sensor 426, and the real-time clock 422, if the dose detection algorithm 416 detects that the data-enabled pharmaceutical container 130 is both opened and tilted simultaneously for a certain amount of time (e.g., a few seconds) a time-stamped valid dose event is logged in the actual dose information 418. The valid dose events that are detected can be compared to information in the patient's dosing regimen 414 in order to determine whether the prescribed dosing regimen is being followed. Namely, using the patient's dosing regimen 414, it can be determined whether doses are taken on time, whether doses have been missed, whether extra doses have been taken, whether early doses have been taken, and/or whether late doses have been taken. Additionally, using the patient's dosing regimen 414 and the dose detection algorithm 416, the processor 412 may be used to activate any of the indicators 320. Further, the time-stamped states of any of the indicators 320 may also be logged in the actual dose information 418.

Table 1 below shows an example of a record of data in the actual dose information 418 that may be compiled using the processor 412 and/or the dose detection algorithm 416. In the example shown in Table 1, the record of data is for one calendar day.

TABLE 1
Example record of data in the actual dose
information 418 for July 12, 2013

Patient Name: John Doe
Patient Address: 487 Elm St, Scranton, PA 18505
RX # 0569790-07365
Medication: LEVOTHROXINE
Dose: Two 50-mg doses daily

| Timestamp Data | Event Data |
|---|---|
| 12-Jul-2013; 06:35:15.2 | “TAKE” LED activated |
| 12-Jul-2013; 07:35:15.2 | “MISSED” LED activated |
| 12-Jul-2013; 07:51:15.7 | Valid dose event detected, “MISSED” LED |
| | deactivated, “TAKEN” LED activated |
| 12-Jul-2013; 08:51:15.7 | “TAKEN” LED deactivated |
| 12-Jul-2013; 19:51:15.7 | “TAKE” LED activated |
| 12-Jul-2013; 20:34:15.4 | Valid dose event detected, “TAKE” LED |
| | deactivated, “TAKEN” LED activated |
| 12-Jul-2013; 21:34:15.4 | “TAKEN” LED deactivated |

While the example shown in Table 1 is a record of data is for one calendar day, the actual dose information 418 can include any number of records, for any number of days. For example, Table 2 below shows an example of a summary report 118 for a 30-day period, wherein the summary report 118 is compiled using the medication adherence application 112 at the application server 110 using information in the actual dose information 418 of a certain patient's data-enabled pharmaceutical container 130. Table 2 also shows the percent medication adherence for the patient for the 30-day period.

TABLE 2
Example summary report 118 for a 30-day period

Patient Name: John Doe
Patient Address: 487 Elm St, Scranton, PA 18505
RX # 0569790-07365
Medication: LEVOTHROXINE
Start: June 15, 2013
Duration: 30 days
Dose: One 50-mg dose daily
Dose Time: 08:00 ± 2 hours
Summary: Taken = 24 doses, Missed = 6 doses, Adherence = 80%

| Day | Date | Time | Status |
|---|---|---|---|
| Saturday | 06/15/2013 | 07:58 | Taken |
| Sunday | 06/16/2013 | 09:05 | Taken |
| Monday | 06/17/2013 | 10:01 | Missed |
| Monday | 06/17/2013 | 13:05 | Late |
| Tuesday | 06/18/2013 | 06:30 | Taken |
| Wednesday | 06/19/2013 | 08:15 | Taken |
| Thursday | 06/20/2013 | 07:45 | Taken |
| Friday | 06/21/2013 | 07:51 | Taken |
| Saturday | 06/22/2013 | 10:01 | Missed |
| Sunday | 06/23/2013 | 10:01 | Missed |
| Monday | 06/24/2013 | 10:01 | Missed |
| Tuesday | 06/25/2013 | 08:30 | Taken |
| Wednesday | 06/26/2013 | 06:15 | Taken |
| Wednesday | 06/26/2013 | 09:37 | Extra |
| Thursday | 06/27/2013 | 07:32 | Taken |
| Friday | 06/28/2013 | 07:34 | Taken |
| Saturday | 06/29/2013 | 08:12 | Taken |
| Sunday | 06/30/2013 | 09:15 | Taken |
| Monday | 07/01/2013 | 09:57 | Taken |
| Tuesday | 07/02/2013 | 07:25 | Taken |
| Wednesday | 07/03/2013 | 09:21 | Taken |
| Thursday | 07/04/2013 | 07:43 | Taken |
| Friday | 07/05/2013 | 08:09 | Taken |
| Saturday | 07/06/2013 | 05:44 | Early |
| Saturday | 07/06/2013 | 10:01 | Missed |
| Sunday | 07/07/2013 | 07:19 | Taken |
| Monday | 07/08/2013 | 10:01 | Missed |
| Tuesday | 07/09/2013 | 10:01 | Missed |
| Wednesday | 07/10/2013 | 10:01 | Missed |
| Thursday | 07/11/2013 | 07:34 | Taken |
| Friday | 07/12/2013 | 08:42 | Taken |
| Saturday | 07/13/2013 | 09:48 | Taken |
| Sunday | 07/14/2013 | 09:01 | Taken |

Table 3 below shows an example of an exception report 120 that is based on the information in Table 2 for the same 30-day period, wherein the exception report 120 is compiled using the medication adherence application 112 at the application server 110.

TABLE 3
Example exception report 120 based on Table 2

Patient Name: John Doe
Patient Address: 487 Elm St, Scranton, PA 18505
RX # 0569790-07365
Medication: LEVOTHROXINE
Start: June 15, 2013
Duration: 30 days
Dose: One 50-mg dose daily
Dose Time: 08:00 ± 2 hours
Summary: Total Exceptions = 9, Missed doses = 6, Early doses = 1,
Late doses = 1, Extra doses = 1

| Day | Date | Time | Status |
|---|---|---|---|
| Monday | 06/17/2013 | 10:01 | Missed |
| Monday | 06/17/2013 | 13:05 | Late |
| Saturday | 06/22/2013 | 10:01 | Missed |
| Sunday | 06/23/2013 | 10:01 | Missed |
| Monday | 06/24/2013 | 10:01 | Missed |
| Wednesday | 06/26/2013 | 09:35 | Extra |
| Saturday | 07/06/2013 | 05:44 | Early |
| Monday | 07/08/2013 | 10:01 | Missed |
| Tuesday | 07/09/2013 | 10:01 | Missed |
| Wednesday | 07/10/2013 | 10:01 | Missed |

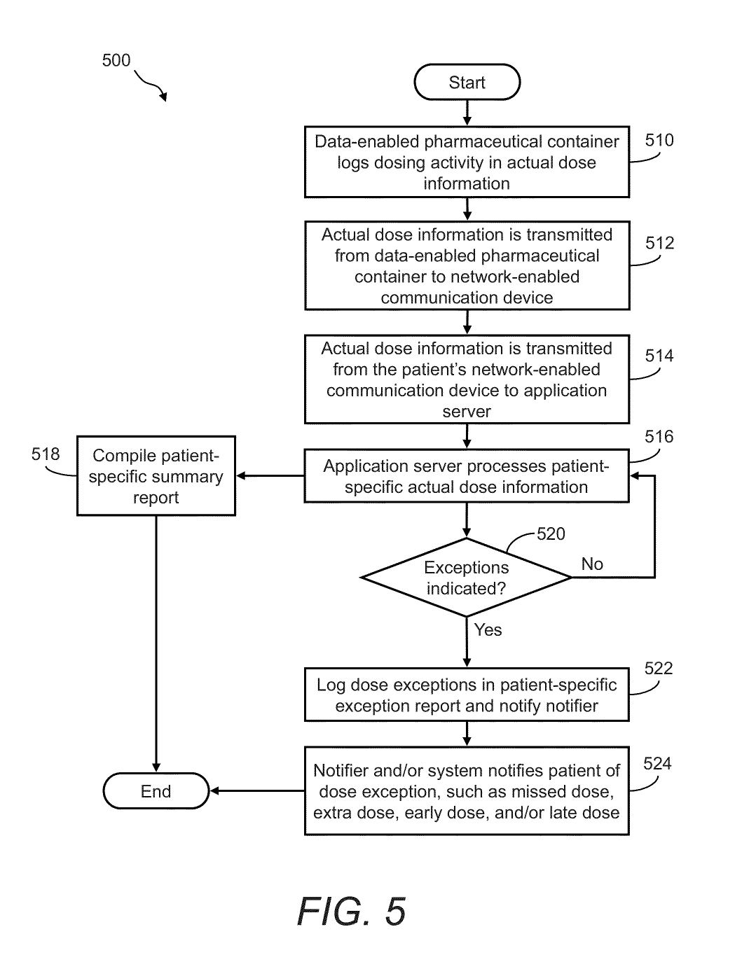

FIG. 5 illustrates a flow diagram of an example of a method 500 of using the presently disclosed medication adherence system 100 and/or 200 for monitoring a patient 150's medication adherence and facilitating dose reminder notifications. Method 500 may include, but is not limited to, the following steps.

At a step 510, the data-enabled pharmaceutical container 130 logs dosing activity in actual dose information 418. For example, by monitoring the states of the momentary contact switch 424, the tilt sensor 426, and the real-time clock 422, if the dose detection algorithm 416 detects that the data-enabled pharmaceutical container 130 is both opened and tilted simultaneously for a certain amount of time (e.g., from about 2 sec to about 5 sec, or about 3 sec) a time-stamped valid dose event is logged in the actual dose information 418. The valid dose events that are detected can be compared to information in the patient's dosing regimen 414 in order to determine whether the prescribed dosing regimen is being followed. Namely, using the patient's dosing regimen 414, it can be determined whether doses are taken on time, whether doses have been missed, whether extra doses have been taken, whether early doses have been taken, and/or whether late doses have been taken. Further, the time-stamped states of any of the indicators 320 can also be logged in the actual dose information 418. An example of dosing activity that can be logged in actual dose information 418 is shown above in Table 1.

At a step 512, the contents of the actual dose information 418 is transmitted from the data-enabled pharmaceutical container 130 to the network-enabled communication device, such as the mobile phone 140 or the computing device 240. The method 500 proceeds to a step 514.

In one example, the data-enabled pharmaceutical container 130 may periodically push the contents of the actual dose information 418 to the mobile phone 140 or to the computing device 240. For example, using Bluetooth technology in the communications interface 410, the processor 412 of the data-enabled pharmaceutical container 130 is programmed to push the actual dose information 418 once per day, twice per day, three times per day, four times per day, or at some other interval to the medication adherence mobile app 142 of the mobile phone 140 and/or to the mobile/desktop medication adherence application 242 of the computing device 240.

In another example, the data-enabled pharmaceutical container 130 may push the contents of the actual dose information 418 in real time to the mobile phone 140 or to the computing device 240. For example, using Bluetooth technology in the communications interface 410, the processor 412 of the data-enabled pharmaceutical container 130 may be programmed to push the actual dose information 418 to the medication adherence mobile app 142 of the mobile phone 140 and/or to the mobile/desktop medication adherence application 242 of the computing device 240 anytime that the actual dose information 418 is updated.

In yet another example, the mobile phone 140 and/or the computing device 240 may periodically pull the contents of the actual dose information 418 from the data-enabled pharmaceutical container 130. For example, using Bluetooth technology, the medication adherence mobile app 142 of the mobile phone 140 and/or the mobile/desktop medication adherence application 242 of the computing device 240 may be programmed to periodically pull the actual dose information 418 from the data-enabled pharmaceutical container 130. The method 500 proceeds to a step 514.

At a step 514, using the cellular network 160 and/or the network 170, the actual dose information 418 may be transmitted from the patient 150's network-enabled communication device to the application server 110. For example, the actual dose information 418 may be transmitted from the medication adherence mobile app 142 of the patient 150's mobile phone 140 and/or the mobile/desktop medication adherence application 242 of the patient 150's computing device 240 to the medication adherence application 112 of the application server 110. Optionally, both the patient 150's actual dose information 418 and dosing regimen 414 may be transmitted from the patient 150's mobile phone 140 or computing device 240 to the application server 110. The method 500 proceeds to a step 516.

At a step 516, the medication adherence application 112 of the application server 110 processes the patient-specific actual dose information 418 received from the patient 150's mobile phone 140 or computing device 240. The method 500 proceeds to a step 518 and to a step 520.

At a step 518, using the contents of the patient-specific actual dose information 418, a patient-specific summary report 118 is compiled. An example of a patient-specific summary report 118 is shown above in Table 2.

At a decision step 520, it may be determined whether any exceptions are indicated in the patient-specific actual dose information 418. For example, it is determined whether any missed doses, extra doses, early doses and/or late doses are indicated the patient-specific actual dose information 418. If at lease one exception is indicated, then the method may proceed to a step 522. However, if no exceptions are indicated, then the method may return to a step 516.

At a step 522, exception information is logged in a patient-specific exception report 120 and a notification of the exception is transmitted to a notifier 155. An example of a patient-specific exception report 120 is shown above in Table 3. For example, a certain notifier 155 is notified (via email, text message, etc.) that a certain patient 150 missed a dose of medication.

At a step 524, a notifier 155 and/or the medication adherence application 112 notifies the patient 150 of the dose exception, such as missed dose, extra dose, early dose, and late dose. In one example, at step 512, the data-enabled pharmaceutical container 130 is programmed to push the actual dose information 418 to the patient 150's mobile phone 140 or computing device 240 once per day at midnight. Then, at step 514 the patient 150's mobile phone 140 or computing device 240 transmits the patient-specific actual dose information 418 to the medication adherence application 112 at the application server 110. Then, at some point, e.g., the next day, a notifier 155 and/or the medication adherence application 112 may notify the patient 150 of, for example, a missed dose. In one example, the next day, the notifier 155 notifies the patient 150 by telephone of the previous day's missed dose. In another example, the next day, the notifier 155 notifies the patient 150 by email or text message of the previous day's missed dose. In yet another example, the next day, the medication adherence application 112 automatically transmits an “exception” notification, such as a “missed dose” notification, to the patient 150 via, for example, email or text message.

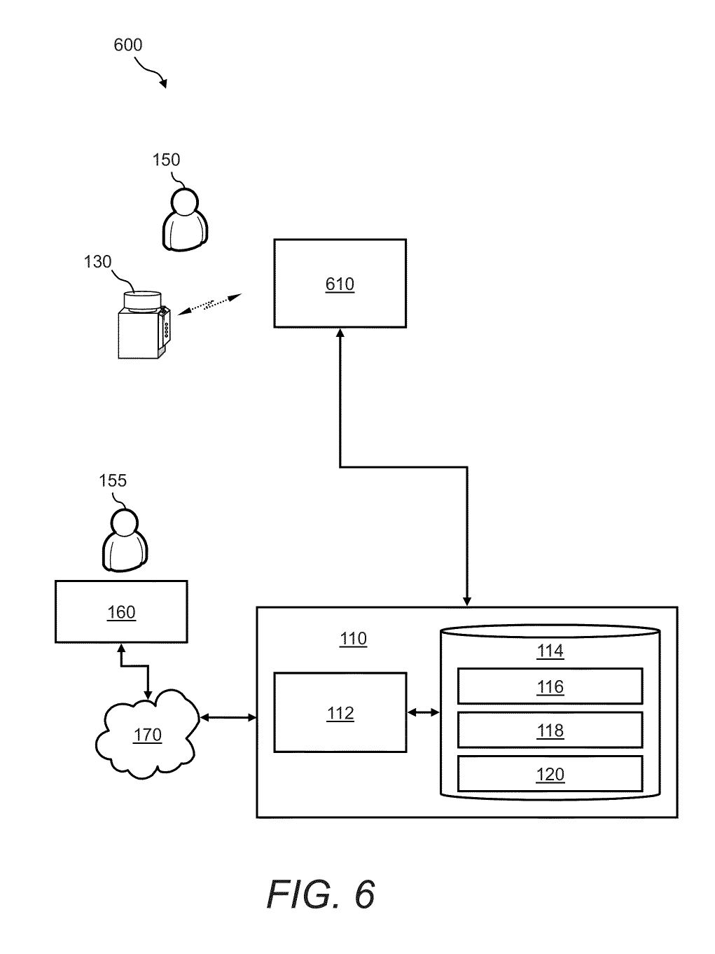

FIG. 6 illustrates a block diagram of a medication adherence system 600 for monitoring a patient's medication adherence and facilitating dose reminder notifications according to yet another embodiment of the invention. Namely, in medication adherence system 600, communication is facilitated primarily via a landline. That is, the medication adherence system 600 is substantially the same as the medication adherence system 100 of FIG. 1, except that the mobile phones 140 and the cellular network 160 are replaced with a Bluetooth-enabled landline (or dial-up) modem 610 and the application server 110 may be a dial-in server, or similar. The Bluetooth-enabled landline (or dial-up) modem 610 provides both landline dial-up capability for communicating with the dial-in application server 110 and Bluetooth technology for communicating with the data-enabled pharmaceutical container 130. Examples of the Bluetooth landline (or dial-up) modem 610 include, but are not limited to, the Sitecom CN-503 Bluetooth Modem available from Sitecom Europe BV (Rotterdam, Zuid-Holland) and the Model 4300 Zoom Bluetooth Modem available from Zoom Telephonics Inc. (Boston, Mass.).

In the medication adherence system 600, the processor 412 may be programmed to transmit the actual dose information 418 and optionally the dosing regimen 414 to the dial-in application server 110 once per day, such as at midnight, or multiple times per day. For example, the data-enabled pharmaceutical container 130 communicates via Bluetooth technology with the Bluetooth landline (or dial-up) modem 610 to initiate a dial-up operation, then transmits the contents of the actual dose information 418 and optionally the dosing regimen 414 to the dial-in application server 110 over a landline.

In still another embodiment of the presently disclosed medication adherence system, the medication adherence system utilizes the cellular network 160, the network 170, the Bluetooth landline (or dial-up) modem 610, and any combinations thereof.

Following long-standing patent law convention, the terms “a,” “an,” and “the” refer to “one or more” when used in this application, including the claims. Thus, for example, reference to “a subject” includes a plurality of subjects, unless the context clearly is to the contrary (e.g., a plurality of subjects), and so forth.

Throughout this specification and the claims, the terms “comprise,” “comprises,” and “comprising” are used in a non-exclusive sense, except where the context requires otherwise. Likewise, the term “include” and its grammatical variants are intended to be non-limiting, such that recitation of items in a list is not to the exclusion of other like items that can be substituted or added to the listed items.

For the purposes of this specification and appended claims, unless otherwise indicated, all numbers expressing amounts, sizes, dimensions, proportions, shapes, formulations, parameters, percentages, parameters, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the presently disclosed subject matter. For example, the term “about,” when referring to a value can be meant to encompass variations of, in some embodiments, ±100% in some embodiments ±50%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

The foregoing detailed description of embodiments refers to the accompanying drawings, which illustrate specific embodiments of the invention. Other embodiments having different structures and operations do not depart from the scope of the present invention. The term “the invention” or the like is used with reference to certain specific examples of the many alternative aspects or embodiments of the applicant's invention set forth in this specification, and neither its use nor its absence is intended to limit the scope of the applicant's invention or the scope of the claims. This specification is divided into sections for the convenience of the reader only. Headings should not be construed as limiting of the scope of the invention. The definitions are intended as a part of the description of the invention. It will be understood that various details of the present invention may be changed without departing from the scope of the present invention. Furthermore, the foregoing description is for the purpose of illustration only, and not for the purpose of limitation, as the present invention is defined by the claims as set forth hereinafter.

We claim:

1. A medication adherence system, comprising:
a) an application server;
b) a data-enabled pharmaceutical container; and
c) a communication device, wherein the communication device is in communication with the application server and the data-enabled pharmaceutical container.

2. The system of claim 1 wherein the communication device is in communication with the application server and the data-enabled pharmaceutical container via a network.

3. The system of claim 2 wherein the network comprises a cellular network.

4. The system of claim 1 wherein the application server comprises a centralized server.

5. The system of claim 1 wherein the application server comprises a cloud server.

6. The system of claim 1 wherein the application server comprises a medication adherence application and a database.

7. The system of claim 6 wherein the database is configured to store at least one or more of subscription data, summary reports, and exception reports.

8. The system of claim 1 wherein the data-enabled pharmaceutical container comprises control electronics for one or more of providing reminders at dose time, tracking and communicating valid dose events, missed, extra, early, and late dose events.

9. The system of claim 8 wherein the data-enabled pharmaceutical container further comprises a dose detection algorithm, wherein a dose event is tracked as valid based on sensing that the data-enabled pharmaceutical container is both opened and tilted past a pre-defined minimum threshold angle simultaneously for a pre-defined minimum amount of time.

10. The system of claim 3 wherein the communication device comprises a cellular-enabled mobile device.

11. The system of claim 3 wherein the communication device comprises a mobile telephone.

12. The system of claim 1 wherein the communication device comprises a medication adherence mobile/desktop application configured to run on the communication device.

13. The system of claim 1 wherein the data-enabled pharmaceutical container and the communication device is associated with a particular user.

14. The system of claim 11 wherein the medication adherence mobile/desktop application and the medication adherence application communicate via the network.

15. The system of claim 1 wherein the data-enabled pharmaceutical container and the communication device are in one of wired or wireless communication.

16. The system of claim 1 wherein the communication device communicates with the application server via a cellular network.

17. The system of claim 1 wherein the application server is configured for collecting and processing user specific information from the data-enabled pharmaceutical container transmitted via the communication device.

18. The system of claim 1 wherein the medication adherence system comprises a subscription-based system.

19. The system of claim 1 further comprising one or more notifiers.

20. The system of claim 19 further comprising one or more notifier communication devices associated with the one or more notifiers, wherein the one or more notifier communication devices are in communication with the application server.

21. The system of claim 20 wherein the one or more notifier communication devices comprise any one of a mobile telephone, a landline phone, or any computing device.

22. The system of claim 2 wherein the network provides at least one of a wired or wireless connection to the Internet.

23. The system of claim 2 wherein the communication device comprises a computing device.

24. The system of claim 23 wherein the computing device comprise one of a desktop computer, laptop computer, handheld computing device, mobile phone, personal digital assistant (PDA), or tablet device.

25. The system of claim 23 wherein the computing device comprises a mobile/desktop medication adherence application.

26. The system of claim 23 wherein the computing device is configured to be in one of wired or wireless communication with the data-enabled pharmaceutical containers.

27. The system of claim 1 wherein the communication device comprises a modem.

28. The system of claim 27 wherein the modem comprises a landline modem.

29. The system of claim 1 wherein the system is configured to utilize any one or more of a cellular network, an Internet connection, or modem for communication.

30. A method of using a medication adherence system, the method comprising:
a) automatically recording a user's actual dose information via a data-enabled pharmaceutical container;
b) communicating the user's actual dose information from the data-enabled pharmaceutical container to a communication device;
c) communicating the user's actual dose information from the communication device to an application server;
d) processing the user's actual dose information communicated from the communication device and compiling a user specific summary based on the user's actual dose information;
e) recording any user specific dose exceptions; and
f) notifying at least one of the user, one or more notifiers, or an authorized personnel of the user specific dose exceptions.

31. The method of claim 30 wherein processing the user's actual dose information comprises compiling a user specific summary based on the user's actual dose information.

32. The method of claim 30 wherein the communication device and application server comprises a medication adherence mobile/desktop application and a medication adherence application respectively.

33. The method of claim 30 wherein the user's actual dose information comprises valid dose events detected by the data-enabled pharmaceutical container.

34. The method of claim 33 wherein valid dose events comprises the data-enabled pharmaceutical container being both opened and tilted past a pre-defined minimum threshold angle simultaneously for a pre-defined period of time.

35. The method of claim 30 wherein the user's actual dose information is compared to information in a user's prescribed dosing regimen.

36. The method of claim 30 wherein the user's actual dose information is communicated over a network.

37. The method of claim 30 wherein the data-enabled pharmaceutical container pushes the contents of the user's actual dose information to the communication device in real-time, scheduled intervals, and/or on demand.

38. The method of claim 30 wherein the communication device comprises a one of a mobile phone or a computing device.

39. The method of claim 30 wherein the communication device pulls the contents of the user's actual dose information from the data-enabled pharmaceutical container in real-time, scheduled intervals, and/or on demand.

40. The method of claim 32 wherein the user's actual dose information is communicated from the medication adherence mobile/desktop application of the communication device to the medication adherence application of the application server.

41. The method of claim 30 wherein communicating the user's actual dose information from the data-enabled pharmaceutical container to a communication device and communicating the user's actual dose information from the communication device to the application server is via at least one of a cellular network or an Internet connection.

42. The method of claim 30 wherein a user's prescribed dosing regimen is communicated to the application server.

43. The method of claim 30 wherein user specific dose exceptions comprise any one or more of a missed dose, extra dose, early dose, and/or late dose.

44. The method of claim 30 wherein notifying comprises any one or more of email, text message, telephone call, page, and/or instant message.

45. The method of claim 30 wherein the one or more notifiers or authorized personnel further notifies the user and/or other authorized personnel of the user specific dose exceptions.

46. The method of claim 30 wherein the user specific dose exceptions notification is automatically communicated to at least one of the user, one or more notifiers, or authorized personnel.

47. The method of claim 30 wherein the communication device comprises a modem.

48. The method of claim 47 wherein the modem comprises a landline modem.

49. The method of claim 30 wherein communicating is via any one or more of a cellular network, an Internet connection, or modem.
